(19) United States
(12) Patent Application Publication
(10) Pub. No.: US 2002/0072992 A1
(43) Pub. Date: Jun. 13, 2002

(54) Matching and assisting a buyer and a vendor from an inquiry, through a proposal, and to an order

(76) Inventors: Christopher Mark Elms, Melbourne (CA); David B. Valeriote, London (CA); David D. McKinnon, Toronto (CA)

Correspondence Address: HONEYWELL INTERNATIONAL INC., 101 COLUMBIA ROAD, P O BOX 2245, MORRISTOWN, NJ, 07962-2245, US

(21) Appl. No.: 09/954,593

(22) Filed: Sep. 19, 2001

Related U.S. Application Data
(60) Provisional application No. 60/234,080, filed on Sep. 20, 2000.

(51) Int. Cl. G06F 17/60

(52) U.S. Cl. 705/26

(57) ABSTRACT

There is provided a computer-implemented method for enabling a host to facilitate a transaction between a first party and a second party. The method comprises the steps of: (a) receiving a communication from the first party; (b) querying a database based on the communication and obtaining a result that indicates the second party for engagement in the transaction; (c) sending a communication to the second party inviting the second party to correspond with the first party; (d) receiving a correspondence from the second party; and (e) presenting to the first party the correspondence from the second party.

### CROSS REFERENCE TO RELATED APPLICATIONS

The present application is claiming priority of U.S. Provisional Patent Application Serial No. 60/234,080, filed on Sep. 20, 2000.

### BACKGROUND OF THE INVENTION

1. Field of the Invention

The present invention relates to electronic commerce, and more particularly, to a utility that provides a user of an internet site with the ability to assemble, evaluate and purchase products and services that are available through the site and affiliated sites.

2. Description of the Prior Art

Current business-to-business internet sites, e.g., websites, may offer a mechanism, such as a keyword search or hyper-linked taxonomy, that displays catalog pages to enable a user of the site, e.g., a buyer, to find one or more products that the buyer may wish to purchase from a seller or vendor. The site may also provide the buyer with the ability to assemble the products into a virtual shopping cart and thereafter to order, and to arrange for payment of, the products.

Typically, all of the products in such a virtual shopping cart must come from a single seller or vendor, or from a custom-compiled buyer-side catalog. Such a catalog can be very expensive to create. For example, a catalog that is intended to address a significant business-to-business marketplace may cost millions of dollars. Also, if the buyer wishes to determine whether a particular product is suitable for the buyer's needs, or wishes to determine whether the product offers a competitive advantage, then the buyer must either rely on the description or specification provided in the catalog or perform additional research off-line. Furthermore, these websites are not well suited for the marketing of intangible products or services.

The buyer may browse an on-line catalog and initiate a transaction for the acquisition of a product. In many cases the transaction is completed satisfactorily, but in other cases the buyer cancels the purchase or the transaction fails for some other reason. A marketer could benefit from the knowledge of why a particular transaction succeeds or fails.

### SUMMARY OF THE INVENTION

The present invention provides a web-based utility that introduces a first party, e.g., a buyer, to a second party, e.g., vendor, and facilitates a transaction between the buyer and the vendor.

The present invention also provides such a utility that enables the buyer and vendor to engage in a dialogue with one another.

Furthermore the present invention provides such a utility that permits (a) the buyer to learn of a product or service that can be provided by the vendor, (b) the vendor to offer a proposal for a sale of the product or service to the buyer, and (c) the buyer to accept the offer.

The present invention provides such a utility that facilitates the placement of an order by the buyer and payment by the buyer.

The present invention provides such a utility that gathers information regarding the success or failure of the transaction.

These and other advantages of the present invention are achieved by a computer-implemented method for enabling a host to facilitate a transaction between a first party and a second party. The method comprises the steps of: (a) receiving a communication from the first party; (b) querying a database based on the communication, and obtaining a result that indicates the second party for engagement in the transaction; (c) sending a communication to the second party inviting the second party to correspond with the first party; (d) receiving a correspondence from the second party; and (e) presenting to the first party the correspondence from the second party.

A second computer-implemented method for enabling a host to facilitate a transaction between a first party and a second party comprises the steps of (a) receiving a query from said first party; (b) searching a database, based on said query, for correspondents for engagement in said transaction; (c) sending to said first party, a list of said correspondents that includes said second party; (d) receiving from said first party an indication that said first party desires to correspond with said second party; (e) receiving a correspondence from said first party; (f) presenting to said second party said correspondence from said first party; (g) receiving a correspondence from said second party; and (h) presenting to said first party, said correspondence from said second party.

### BRIEF DESCRIPTION OF THE DRAWINGS

FIG. 1 is a block diagram of a computer system configured for employment of the present invention.

FIG. 2 is a flowchart of a method for facilitating a transaction in accordance with the present invention.

FIG. 3 is an illustration of an exemplary display of a list, as presented to a vendor, that shows pending dialogs involving the vendor.

FIG. 4 is an illustration of an exemplary page of dialog as viewed by a vendor.

FIG. 5 is a flowchart of a hypothetical dialog session involving a buyer and two vendors in accordance with the present invention.

### DESCRIPTION OF THE INVENTION

The present invention is a website utility that introduces a first party, e.g., a buyer, to a second party, e.g., a vendor or seller, and further facilitates a transaction between the two parties. The utility is a software program that interfaces with a database. The database is associated with a search engine that allows the first party to formulate a query, or with a hyper-link navigation utility that allows the first party to navigate to a link, relating to a problem or to a specific product or service. For example, based on the query, the search engine searches the database and returns one or more results indicating second parties that are candidates for, i.e., potentially capable of, either (a) providing the product or service or (b) advising the first party with regard to a selection or specification of the product or service.

The present invention combines user-friendly human-computer interface elements such as forms, folder hierarchy and dialogs. In the context of a business transaction, it provides a unique method for buyers and vendors to collaborate in a problem-solving process, from an initial inquiry through to an order. The utility allows the buyer to establish a virtual file, e.g., a project, that is a data area within which to organize correspondence and other information relating to the transaction. The organization of information within the project area provides a convenient location from which the buyer can further investigate the product or service or compare or evaluate a plurality of products or services. The project organization allows the buyer to conveniently deal with a plurality of vendors, for example, by broadcasting a query to the plurality of vendors. The utility also provides the vendor with a project area within which to organize information relating to the transaction.

Although presented herein in the context of facilitating a business transaction, the term “transaction” also means an exchange of information or correspondence between parties in other suitable scenarios. For example, a first party may seek advice from a second party with respect to a health issue, a religious issue or a political issue. Furthermore, the present invention recognizes that one or both parties may regard the transaction as being one of a confidential nature and, therefore, one or both of the parties may opt to remain anonymous.

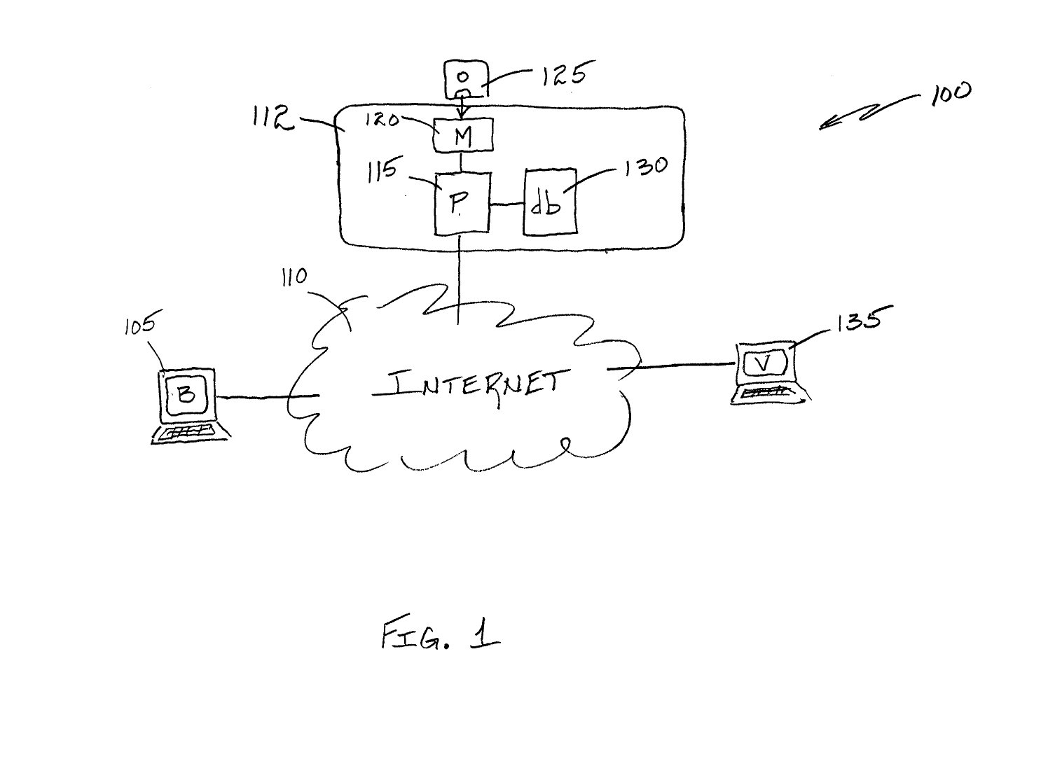

FIG. 1 is a block diagram of a computer system 100 configured for employment of the present invention. The primary components of system 100 include a buyer workstation 105, a vendor workstation 135 and a server 112, each of which is coupled to a computer network, such as the internet 110.

The buyer workstation 105 and the vendor workstation 135 are preferably conventional computers, such as a desktop personal computer (PC). They each typically include a local processor, a memory, a display and a user interface, such as a keyboard. They also include software, such as an internet browser, for sending and receiving data via the internet 110.

The present invention does not contemplate any particular configuration for either the hardware or software of buyer workstation 105 or vendor workstation 135, as any suitable computer system can be employed in these roles. Also, the workstations need not be stationary, but instead can be implemented in a wireless system such as a personal digital assistant, e.g., a Palm Pilot™ available from Palm, Inc., or a cellular telephone.

The terms “dialog” and “correspondence” are intended to encompass any convenient form of communication, such as text, audio and video. Also, although the present invention involves a dialog between a buyer at buyer workstation 105 and a vendor at vendor workstation 135, the buyer and seller, as generators of the dialogue, need not necessarily be human beings but could instead be virtual characters formed by components employing techniques of artificial intelligence. For example, the dialogue generated by the seller may be produced by a component of software associated with vendor workstation 135 rather than by an actual human being. The present invention also contemplates a language translation capability to allow for a dialog between users who speak different languages, such as those of different ethnic or national descent.

Server 112 includes a processor 115, a memory 120 and a database 130. Memory 120 contains one or more software modules that, in turn, contain instructions and data for controlling processor 115 to execute the methods described herein. Also, the website and the search engine are preferably, but not necessarily, resident as software components of server 112.

Although the instructions and data for employment of the present invention are described herein as being installed in memory 120, they can be stored on an external storage media 125 for subsequent loading into memory 120. Storage media 125 can be any conventional storage media, including, but not limited to, a floppy disk, a compact disk, a magnetic tape, a read only memory, or an optical storage media. Storage media 125 could also be a random access memory, or other type of electronic storage, located on a remote storage system and coupled to memory 120.

Database 130 is a memory that contains data relating to the transactions that the present invention serves to facilitate. Such data may include, for example, buyer profiles, vendor profiles, descriptors of products and services available from the vendors, an archive of dialogues between buyers and vendors, and other information relating to the transactions.

The utility of the present invention is managed by a host or administrator that is typically a third party, i.e., not either a buyer or a vendor. The host is thus a middleman, conceptually positioned between the first and second parties. The administrator of the utility could also be the administrator or operator of server 112, but such is not required.

Preferably, the administrator is compensated for facilitating the transaction between the buyer and vendor. The compensation to the administrator may come from either, or both, the buyer and the vendor. However, the compensation need not come from either the buyer or the vendor. For example, the administrator could sell advertising space on the website, where the advertising is targeted to a user of the site based on the nature of the user's correspondence, a user profile, or some other targeting technique.

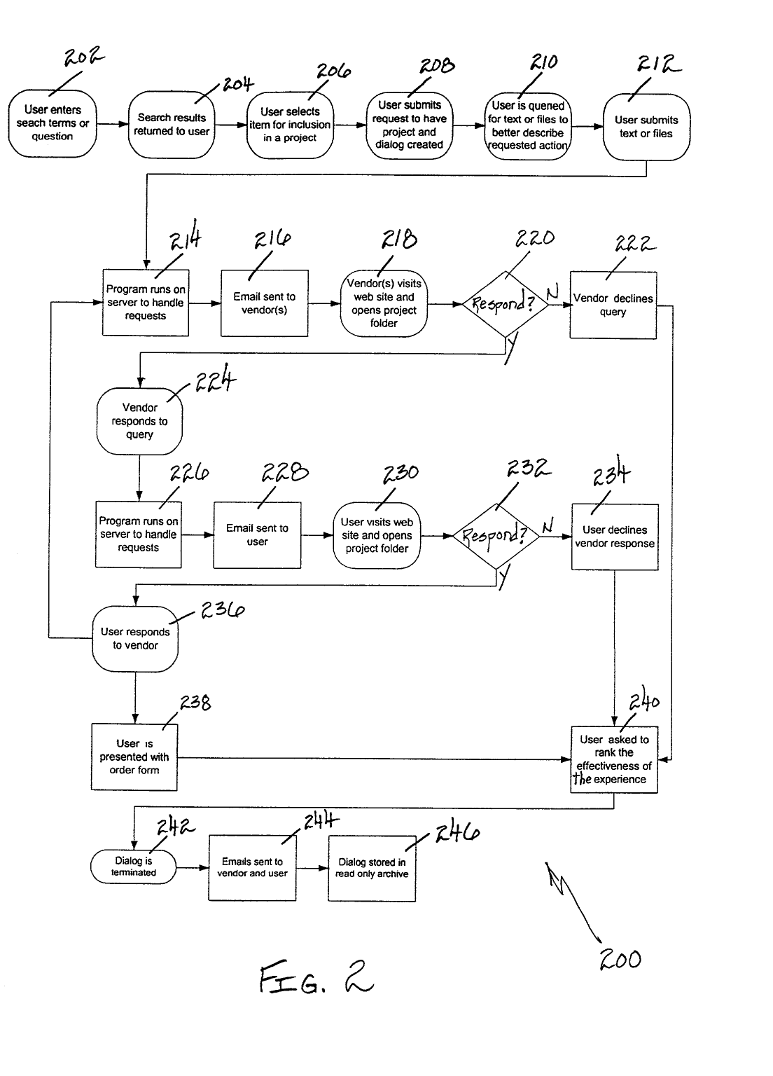

FIG. 2 is a flowchart of a method 200 executed by server 112 for facilitating a transaction in accordance with the present invention. Method 200 commences with step 202.

In step 202, a buyer using buyer workstation 105 formulates a query by presenting one or more search terms or a question to a search engine. For example, the buyer's query may be stated as, “steam turbine turning problem”. The query is transmitted from buyer workstation 105 via the internet 110 to server 112 for presentation to the search engine. Method 100 progresses to step 204.

In step 204, the search engine receives the query, searches database 130, and returns search results to buyer workstation 105. For example, the search results can include a list of vendors that sell steam turbines, steam turbine components, or steam turbine maintenance supplies. The search results may also include a list of vendors that service steam turbines or that provide consulting services relating to steam turbine operation. Method 200 progresses to step 206.

In step 206, the buyer selects from the list of search results one or more vendors with whom the buyer would like to engage in a dialogue or some other exchange of correspondence. Method 200 progresses to step 208.

In step 208, the utility gives the buyer an opportunity to create a new project in a project folder. In one implementation of the present invention, the project is automatically given a name taken from the terms of the search. So, for example, assume a project named “steam turbine turning problem” is created in a project folder named “MyProject”. The buyer can create, within the new project or within an existing project, a dialog page, or dialog pages, for use in corresponding with each of the selected vendors. After the buyer creates the dialog page, the buyer submits to server 112 the dialog page and a request for server 112 to create the project folder. Method 200 progresses to step 210.

In step 210, server 112 receives the request that was submitted by the buyer in step 208 and responds by providing a form for display on buyer workstation 105 on which the buyer can enter text, audio and video, e.g., attach an electronic file, to further describe the buyer's problem or to make a request of the vendors to take some particular action. This step can be implemented by presenting the buyer with one or more questions that help to better define the nature of the problem the buyer wishes to solve. Method 200 progresses to step 212.

In step 212, the buyer submits to server 112, the completed form from step 210. Method 200 progresses to step 214.

In step 214, server 112 creates database records for database 130 and generates new entries in the buyer's project folder. Server 112 also creates a new entry in a project folder for each of the selected vendors. The generation of the new entries can be performed using any suitable technique, such as by generating hypertext markup language (HTML) code. Method 200 progresses to step 216.

In step 216, server 112 sends a message, e.g., an email, to each of the selected vendors. The email notifies a recipient vendor that a new entry has been created in the vendor's project folder. Method 200 progresses to step 218.

In step 218, a vendor using vendor workstation 135, in response to receipt of the email, visits the website and checks the new contents of the vendor's project folder. Method 200 progresses to step 220.

In step 220, the vendor indicates to server 112 whether the vendor wishes to respond to the buyer's request/question. If the vendor does not wish to respond, then method 200 progresses to step 222. If the vendor wishes to respond, then method 200 advances to step 224.

In step 222, since the vendor does not wish to respond, server 112 updates database 130 to terminate the dialog between the buyer and the vendor. Method 200 then advances to step 240.

In step 224, the vendor responds to the request/question from the buyer. In the response, the vendor can include any appropriate correspondence. For example, the vendor may:

(a) perform the action requested by the buyer;

(b) answer the question asked by the buyer;

(c) ask a question of the buyer; or

(d) submit a proposal to the buyer.

The proposal includes, for example, terms and conditions relating to a sale of product or service from the vendor to the buyer. In the preferred embodiment, server 112 provides a form for display on vendor workstation 135 with which the vendor can enter text and attach an electronic file, e.g., audio and video. This feature permits the vendor to either attach or provide a link to a document relating to the dialog with the buyer. For example, the vendor can provide a link to a page showing a particularly relevant product or other information. Method 200 progresses to step 226.

In step 226, server 112 updates the project folders of the buyer and the vendor in database 130. Method 200 progresses to step 228.

In step 228, server 112 sends a message, e.g., an email, to the buyer to notify the buyer of a new entry in the buyer's project folder. Method 200 progresses to step 230.

In step 230, the buyer accesses the website and opens the buyer's project folder. In each of the dialog pages associated with vendors that have responded, the buyer finds a dialog report that shows the buyer's initial request/question and the vendor's response. Method 200 progresses to step 232.

In step 232, the buyer indicates to server 112 whether the buyer wishes to respond to the correspondence from the vendor. Also in step 232, in the case where the vendor submitted a proposal in step 224, the buyer may decide to reject the proposal and discontinue further correspondence with the vendor. If the buyer does not wish to respond, then method 200 progresses to step 234. If the buyer does wish to respond, then method 236 advances to step 236.

In step 234, since the buyer does not wish to respond, server 112 updates database 130 to terminate the dialog between the buyer and the vendor. Optionally, in the case where the buyer, in step 232, decided to reject the proposal and discontinue correspondence, server 112 can send an email to the vendor to notify the vendor of the buyer's decision. Method 200 then advances to step 240.

In step 236, the buyer responds to the correspondence from the vendor. The buyer indicates to server 112 whether the buyer wishes to:

(1) continue with further correspondence to the vendor; or

(2) accept a proposal that was submitted by the vendor (see step 224).

For the further correspondence, for example, the buyer may:

(a) answer a question that was presented by the vendor;

(b) ask a question of the vendor;

(c) send additional information to the vendor;

(d) respond to the vendor's submission of a proposal (see step 224); or

(e) request a proposal from the vendor.

If the buyer wishes to continue with further correspondence, then method 200 loops back to step 214. The loop back to step 214 can be executed through as many volleys of correspondence as desired by the buyer and vendor. In this manner, both parties have an opportunity to further clarify an issue or to elevate the level of correspondence to a more conclusive action, such as a proposal, a bid and eventually an order. If the buyer wishes to accept a proposal, then method 200 advances to step 238.

In step 238, server 112 presents to the buyer an order form for the vendor's product or service. Preferably, the form is customized to include any terms and conditions agreed upon by the buyer and seller in the course of their correspondence. Server 112 sends a copy of the form to the vendor. The buyer's completion of the form is intended to advance the relationship between the buyer and vendor from one of negotiation to that of obligation. Preferably, a legally binding electronic signature secures the rights and obligations of the buyer and vendor. Server 112 arranges for payment of the purchase from the buyer. The arrangement of payment may include an electronic funds transfer, an access to a line of credit, or a currency translation. The method then advances to step 240.

In step 240, server 112 sends a form to the buyer seeking to obtain feedback relating to the buyer's ranking of the vendor. For example, the form may request the buyer to comment on the buyer's level of satisfaction with the vendor, e.g., “Please rank this vendor”, where the buyer may indicate a ranking between 1 and 5.

In step 242, the dialog is terminated. A status for the dialog is changed from “active” to “archived” and, as indicated below in step 246, the dialog is thereafter available as “read only”. Server 112 determines an amount of compensation payable to the administrator of the utility for facilitating the transaction between the buyer and the vendor.

In step 244, server 112 sends an email to the buyer and an email to the vendor to inform each of these parties that the dialog is now discontinued. Method 200 then advances to step 246.

In step 246, server 112 updates database 130 to save the dialog in an archive (read only) version of the project. Server 112 updates database 130 to maintain a complete record of the correspondence between the buyer and the vendor. Such a record can be indexed by the original search results and accessed and displayed by either the buyer or the vendor.

Preferably, in addition to the exchange of correspondence by email, the present invention provides for a real-time chat between the buyer and vendor. As such, the exchange need not be in written format, but instead, by way of a spoken dialog between the parties.

To further facilitate the transaction, the present invention also provides a scheduling tool that the buyer and vendor can use to schedule virtual meeting times, or set dates for milestones. The tool can be employed at any time during the transaction, even after the order is placed. As such, the transaction can be extended and further managed beyond the point of order placement, to include delivery, installation, follow-up and maintenance.

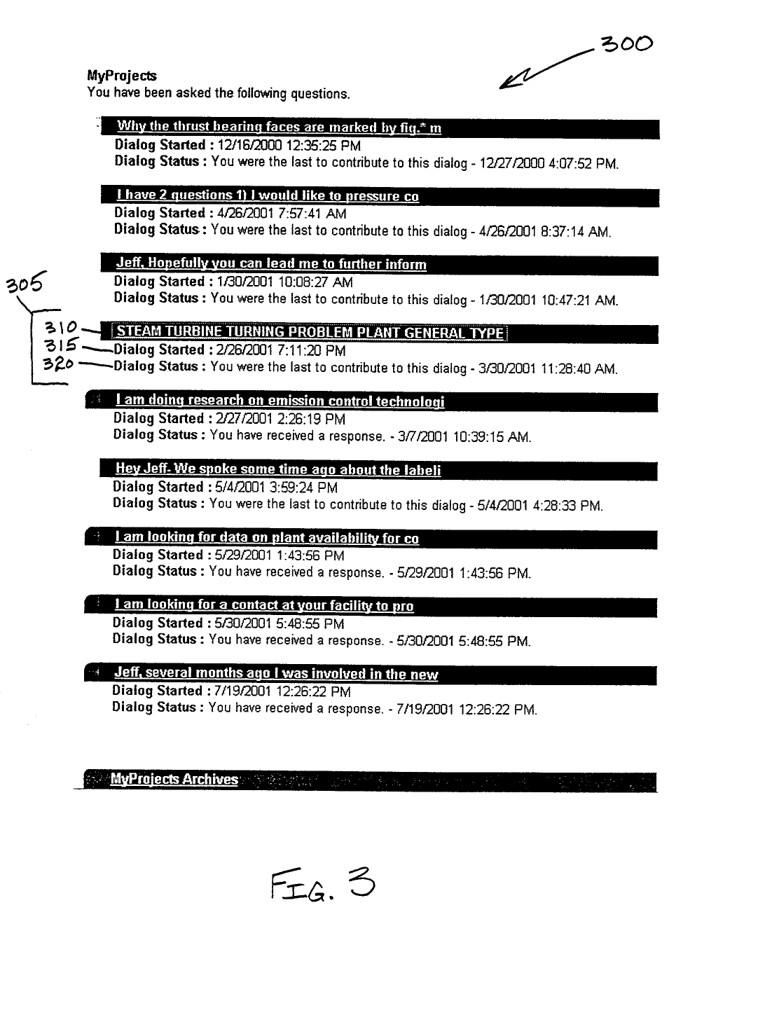

FIG. 3 is an illustration of an exemplary display of a list 300, as presented to a vendor, that shows pending dialogs involving the vendor. List 300 shows a plurality of pending dialogs, one of which is dialog 305. Dialog 305 is identified by a title 310, in this example, “STEAM TURBINE TURNING PROBLEM PLANT GENERAL TYPE”. List 300 also shows, for dialog 305, a dialog start time 315 and a dialog status 320. In this example, dialog status 320 indicates that the vendor was “the last to contribute to this dialog”.

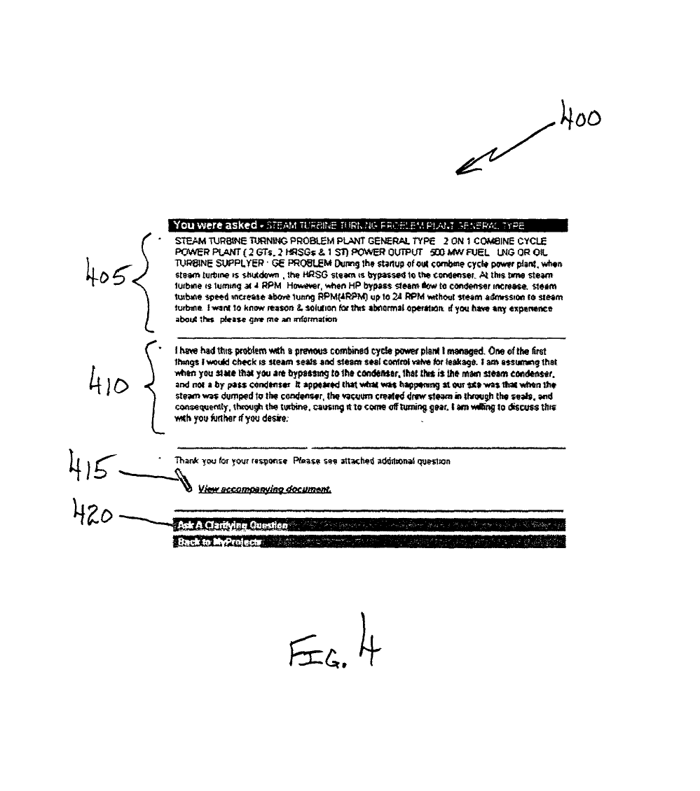

FIG. 4 is an illustration of an exemplary page 400 of dialog as viewed by a vendor. Page 400 includes a message 405 from a buyer to the vendor, and a message 410 from the vendor to the buyer. Page 400 also includes a link 415 to an attached document, and a navigation button 420 to a page from which the vendor can ask a clarifying question of the buyer. Likewise, the buyer can access a page similar to that shown in FIG. 4. Thus, the present invention provides each of the buyer and vendor with a central, segregated area within which to maintain communication with one another.

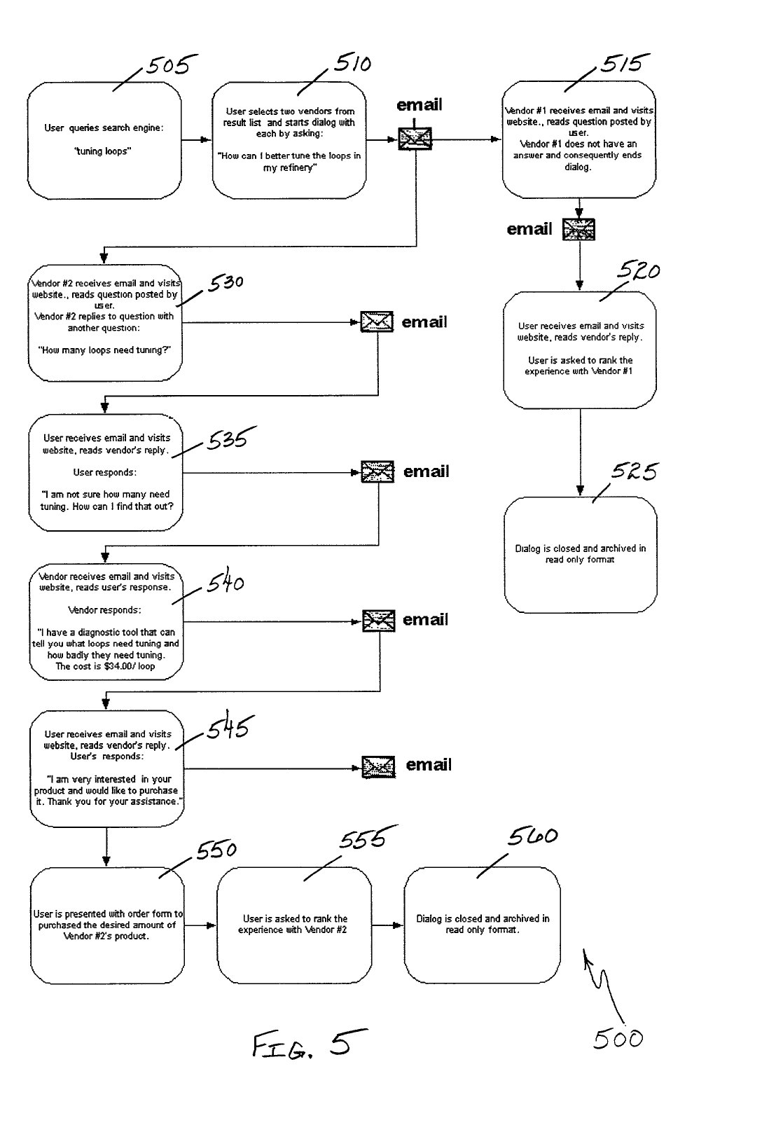

FIG. 5 is a flowchart of a hypothetical dialog session 500 involving a buyer and two vendors in accordance with the present invention. Session 500 begins with step 505.

In step 505, the buyer submits a query, “tuning loops”, to server 112. Server 112 employs a search engine to search database 130. Session 500 progresses to step 510.

In step 510, the buyer selects two vendors, namely Vendor #1 and Vendor #2, from a result list and initiates a dialog with both vendors by asking a question, “How can I better tune the loops in my refinery?” Server 112 sends an email to Vendor #1, where session 500 continues with step 515, and server 112 also sends an email to Vendor #2, where session 500 continues with step 530.

In step 515, Vendor #1 receives the email, visits the website, and reads the question that was posted by the buyer in step 510. Vendor #1 does not have an answer. Consequently, the dialog between the buyer and Vendor #1 is discontinued. Server 112 sends an email to the buyer indicating that the dialog with Vendor #1 is discontinued. Session 500 progresses to step 520.

In step 520, the buyer receives the email, visits the website, and reads the replay from Vendor #1. Server 112 asks the buyer to rank the buyer's experience with Vendor #1. Session 500 progresses to step 525.

In step 525, server 112 closes the dialog between the buyer and Vendor #1, and saves a read-only copy of the dialog in database 130.

In step 530, Vendor #2 receives the email that resulted from step 510, visits the website, and reads the question that was posted by the buyer in step 510. Vendor #2 replies to the question with another question, “How many loops need tuning?” Server 112 sends an email to the buyer. Session 500 progresses to step 535.

In step 535, the buyer receives the email that was sent in step 530, visits the website, reads the reply from Vendor #2, and further responds with, “I am not sure how many need tuning. How can I find that out?” Server 112 sends an email to Vendor #2. Session 500 progresses to step 540.

In step 540, Vendor #2 receives the email that was sent in step 535, visits the website, and reads the buyer response. Vendor #2 responds, “I have a diagnostic tool that can tell you what loops need tuning and how badly they need tuning. The cost is $34.00 per loop.” Server 112 sends an email to the buyer, and session 500 progresses to step 545.

In step 545, the buyer receives the email that was sent in step 540, visits the website, and reads the reply from Vendor #2. The buyer then responds, “I am very interested in your product and would like to purchase it. Thank you for your assistance.” The buyer also indicates to server 112 that the buyer wishes to place an order with Vendor #2. Server 112 sends an email to Vendor #2. Although not shown in FIG. 5, Vendor #2 receives this email and visits the website to read the buyer's correspondence. After step 545, session 500 progresses to step 550.

In step 550, server 112 presents the buyer with an order form to purchase the product, i.e., the diagnostic tool, from Vendor #2. The buyer completes the form and dispatches it to server 112. Server 112 sends the order to Vendor #2 and arranges for payment of the purchase from the buyer. Server 112 also determines an amount of compensation payable to the administrator of the utility for facilitating the transaction between the buyer and Vendor #2. Session 500 progresses to step 555.

In step 555, server 112 asks the buyer to rank the buyer's experience with Vendor #2. Session 500 progresses to step 560.

In step 560, server 112 closes the dialog between the buyer and Vendor #2, and saves a read-only copy of the dialog in database 130.

The following several paragraphs describe some of the advantages of the present invention over current systems.

The buyer may select items for inclusion in a project from a plurality of vendors or affiliated websites. The website of the present invention permits the buyer to engage in correspondence and negotiations with vendors that may be competitors of one another. This allows the buyer to conveniently compare the quality of vendor responses and prices.

The present invention is a relatively inexpensive alternative to a comprehensive catalog. Since the search for information is not limited by that available in a catalog, the pool of vendors is much greater than that typically represented in the catalog, and the buyer may be introduced to a vendor that the buyer would not have found by searching the catalog. Furthermore, since the buyer is given an opportunity to present a query to a plurality of vendors, the vendors may respond by offering a product or service that is not represented in the catalog. Also, the exchange of correspondence between the buyer and the vendor allows both parties to better define the buyer's requirements and the appropriate product or service for those requirements. Such exchanges are particularly useful where the vendor provides an intangible product, e.g., advertising time on a radio station, or advice.

In a case where a buyer includes a team of members working together on a task, the project organization provides for a convenient access point for a secure collaboration area such as a discussion group or an extranet. This is particularly useful where the team members are not necessarily co-located with one another.

The user satisfaction/ranking feature of the present invention provides insight into questions such as:

(1) What are the most common problems that buyers are trying to solve?

(2) What are the most/least popular products or product combinations?

(3) Which vendors are the most effective at answering questions and addressing the problems of the buyers?

Analysis of the database of questions and answers allows the administrator to suggest bundles of products and services to recommend a “best” solution to the most common and difficult problems. This will also permit the administrator to create branded products from the information captured from the database. For example, patterns or relationships between questions asked and resulting products purchased will be determined, and thereafter, if a buyer asks questions associated with the patterns, then a product or a group of products will be suggested to the buyer. The present invention thus provides the administrator of the utility with a unique opportunity to employ the system as a customer relationship management tool.

Also, since the system has access to correspondence from both parties, it can serve as a central repository for details of current and archived transactional events such as:

(1) open and closed bidding;

(2) subscription status;

(3) enrollment information;

(4) open purchase orders;

(5) responses to postings such as job postings; and

(6) notification of product improvements, e.g., software upgrades.

The host website can be implemented in a manner that requires an advance registration of a user before that user is permitted access to the site, but such registration is not mandatory. For example, a buyer, during a first-time use of the website, may be permitted to submit a query and merely provide a password so the buyer can subsequently review the search results. A vendor need not have any preexisting knowledge of the website. For example, if the search engine lists the vendor in the search results, and the buyer selects that vendor, the utility of the present invention can send an introductory email to the vendor inviting the vendor to participate in an exchange of correspondence with the buyer.

It should be understood that various alternatives and modifications of the present invention could be devised by those skilled in the art. As such, the present invention is intended to embrace all such alternatives, modifications and variances that fall within the scope of the appended claims.

What is claimed is:

1. A computer-implemented method for enabling a host to facilitate a transaction between a first party and a second party, comprising:
receiving a communication from said first party;
querying a database based on said communication, and obtaining a result that indicates said second party for engagement in said transaction;
sending a communication to said second party inviting said second party to correspond with said first party;
receiving a correspondence from said second party; and
presenting to said first party said correspondence from said second party.

2. The computer-implemented method of claim 1, further comprising:
storing to a memory a correspondence from said first party;
storing to said memory said correspondence from said second party; and
providing to said first party and said second party access to said memory to review both of said correspondence from said first party and said correspondence from said second party.

3. The computer-implemented method of claim 1, further comprising presenting to said first party an offer for said second party to provide a product or service to said first party.

4. The computer-implemented method of claim 3, further comprising:
receiving from said first party, a communication indicating a desire of said first party to receive said product or service; and
sending an order to said second party for said second party to provide said product or service to said first party.

5. The computer-implemented method of claim 1, further comprising soliciting a comment from said first party regarding said first party's level of satisfaction with said correspondence from said second party.

6. The computer-implemented method of claim 1, further comprising determining an amount of compensation due to said host for facilitating said transaction.

7. The computer-implemented method of claim 1,
wherein said correspondence from said second party is in a first language; and
wherein said method further comprises translating said correspondence from said first language into a second language.

8. A computer-implemented method for enabling a host to facilitate a transaction between a first party and a second party, comprising:
receiving a query from said first party;
searching a database based on said query for correspondents for engagement in said transaction;
sending to said first party a list of said correspondents that includes said second party;
receiving from said first party an indication that said first party desires to correspond with said second party;
receiving a correspondence from said first party;
presenting to said second party said correspondence from said first party;
receiving a correspondence from said second party; and
presenting to said first party said correspondence from said second party.

9. The computer-implemented method of claim 8, further comprising:
storing to a memory said correspondence from said first party;
storing to said memory said correspondence from said second party; and
providing to said first party and said second party access to said memory to review both of said correspondence from said first party and said correspondence from said second party.

10. The computer-implemented method of claim 8 further comprising presenting to said first party an offer for said second party to provide a product or service to said first party.

11. The computer-implemented method of claim 10 further comprising:
receiving from said first party a communication indicating a desire of said first party to receive said product or service; and
sending an order to said second party for said second party to provide said product or service to said first party.

12. The computer-implemented method of claim 8 further comprising determining an amount of compensation due to said host for facilitating said transaction.

13. The computer-implemented method of claim 8
wherein said correspondence from said first party is in a first language and said correspondence from said second party is in a second language, and
wherein said method further comprises at least one of (a) translating said correspondence from said first party from said first language into said second language, or (b) translating said correspondence from said second party from said second language into said first language.

14. A storage media containing instructions for controlling a processor to perform a method for enabling a host to facilitate a transaction between a first party and a second party, said storage media comprising instructions for controlling said processor to execute the steps of:
receiving a communication from said first party;
querying a database based on said communication and obtaining a result that indicates said second party for engagement in said transaction;
sending a communication to said second party inviting said second party to correspond with said first party;
receiving a correspondence from said second party; and
presenting to said first party said correspondence from said second party.

15. The storage media of claim 14 further comprising instructions for controlling said processor to execute the steps of:
storing to a memory a correspondence from said first party;
storing to said memory said correspondence from said second party; and
providing to said first party and said second party access to said memory to review both said correspondence from said first party and said correspondence from said second party.

16. The storage media of claim 14 further comprising instructions for controlling said processor to execute the step of presenting to said first party an offer for said second party to provide a product or service to said first party.

17. The storage media of claim 16, further comprising instructions for controlling said processor to execute the steps of:
receiving from said first party a communication indicating a desire of said first party to receive said product or service; and
sending an order to said second party for said second party to provide said product or service to said first party.

18. The storage media of claim 14, further comprising instructions for controlling said processor to execute the step of soliciting a comment from said first party regarding said first party's level of satisfaction with correspondence from said second party.

19. The storage media of claim 14, further comprising instructions for controlling said processor to execute the step of determining an amount of compensation due to said host for facilitating said transaction.

20. The storage media of claim 14,
wherein said correspondence from said second party is in a first language, and
wherein said storage media further comprises instructions for controlling said processor to execute the step of translating said correspondence from said first language into a second language.

21. A storage media containing instructions for controlling a processor to perform a method for enabling a host to facilitate a transaction between a first party and a second party, said storage media comprising instructions for controlling said processor to execute the steps of:
receiving a query from said first party;
searching a database, based on said query, for correspondents for engagement in said transaction;
sending to said first party a list of said correspondents that includes said second party;
receiving from said first party an indication that said first party desires to correspond with said second party;
receiving a correspondence from said first party;
presenting to said second party said correspondence from said first party;
receiving a correspondence from said second party; and
presenting to said first party said correspondence from said second party.

22. The storage media of claim 21, further comprising instructions for controlling said processor to execute the steps of:
storing to a memory said correspondence from said first party;
storing to said memory said correspondence from said second party; and
providing to said first party and said second party access to said memory to review both said correspondence from said first party and said correspondence from said second party.

23. The storage media of claim 21 further comprising instructions for controlling said processor to execute the step of presenting to said first party an offer for said second party to provide a product or service to said first party.

24. The storage media of claim 23, further comprising instructions for controlling said processor to execute the steps of:
receiving from said first party a communication indicating a desire of said first party to receive said product or service; and
sending an order to said second party for said second party to provide said product or service to said first party.

25. The storage media of claim 21 further comprising instructions for controlling said processor to execute the step of determining an amount of compensation due to said host for facilitating said transaction.

26. The storage media of claim 21,
wherein said correspondence from said first party is in a first language and said correspondence from said second party is in a second language, and
wherein said storage media further comprises instructions for controlling said processor to execute at least one of the steps of (a) translating said correspondence from said first party from said first language into said second language, or (b) translating said correspondence from said second party from said second language into said first language.

27. A computer system for enabling a host to facilitate a transaction between a first party and a second party, comprising:
a module for receiving a communication from said first party;
a module for querying a database based on said communication and obtaining a result that indicates said second party for engagement in said transaction;
a module for sending a communication to said second party inviting said second party to correspond with said first party;
a module for receiving a correspondence from said second party; and
a module for presenting to said first party said correspondence from said second party.

28. A computer system for enabling a host to facilitate a transaction between a first party and a second party, comprising:
a module for receiving a query from said first party;
a module for searching a database, based on said query, for correspondents for engagement in said transaction;
a module for sending to said first party a list of said correspondents that includes said second party;
a module for receiving from said first party an indication that said first party desires to correspond with said second party;
a module for receiving a correspondence from said first party;
a module for presenting to said second party said correspondence from said first party;
a module for receiving a correspondence from said second party; and
a module for presenting to said first party said correspondence from said second party.
